(19) United States
(12) Patent Application Publication
(10) Pub. No.: US 2005/0013325 A1
(43) Pub. Date: Jan. 20, 2005

(54) Method for transmitting multimedia data in wireless network

(75) Inventors: Hyong-uk Choi, Seoul (KR); Jun-whan Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/893,309

(22) Filed: Jul. 19, 2004

(30) Foreign Application Priority Data
Jul. 18, 2003 (KR) 10-2003-0049161

(51) Int. Cl. H04J 3/06

(52) U.S. Cl. 370/508; 370/519

(57) ABSTRACT

A method for transmitting multimedia data in a wireless network using an access point, comprising receiving information on a data quantity from each of stations, and assigning and sending a waiting time to each of the stations based on the received information on the data quantity. Consistent with another aspect of the present invention, there is provided a method for transmitting multimedia data in a wireless network using an access point, comprising providing, by each of stations, information on data quantity to the access point, receiving a waiting time assigned by the access point based on the received information on the data quantity, and transferring, by each station, the data through contention in accordance with the assigned waiting time.

This application claims priority to Korean Patent Application No. 10-2003-0049161, filed on Jul. 18, 2003 in the Korean Intellectual Property Office, the disclosure of which is incorporated herein in its entirety by reference.

### BACKGROUND OF THE INVENTION

1. Field of Invention

The present invention relates to a method for transmitting multimedia data in a wireless network, and more particularly, to a method for transmitting multimedia data in a wireless network wherein a waiting time is assigned by an access point in inverse proportion to the quantity of multimedia data to be transmitted by each station per unit time. Thus, multimedia data are transferred according to data transmission quantity.

2. Description of the Related Art

Generally, IEEE 802.11 protocol is currently standardized into a Medium Access Control (MAC) layer and a physical layer.

The IEEE 802.11 WLAN (Wireless Local Area Network) includes an access point (hereinafter referred to as “AP”) for converting a frame of a 802.11 network into another type of frame to forward the converted frame to other networks, i.e. for performing a bridging function between wired and wireless networks, and a station such as a notebook and a PDA (Personal Digital Assistant) on which a wireless LAN device capable of interfacing with the wireless network is mounted.

Further, IEEE 802.11 WLAN has a basic service set (hereinafter referred to as “BSS”) as a basic configuration that refers to a group of stations communicating with one another.

BSS includes an independent BSS in which a station communicates directly with the other stations, and an infrastructure BSS in which a station always communicates with the other stations via an AP. That is, in the case of infrastructure BSS, since communication is only made between stations via an AP, direct communication between stations is not possible.

Moreover, a basic MAC configuration consists of a distributed coordination function (hereinafter, referred to as “DCF”) based on a carrier sense multiple access (CSMA).

A method of transmitting data in a DCF interval will be explained. First, when intending to transfer data, a MAC observes whether a channel is in use or not. If the channel is “busy”, the MAC performs a backoff to wait for a random time. Otherwise (i.e., if the channel is idle), the MAC transmits the data. Here, the backoff is set using a binary backoff mechanism, and the 802.11 protocol corresponds to a method of transferring data through contention between stations to reduce the possibility of collision between stations and uses a carrier sense multiple access with collision avoidance (CSMA/CA) for avoiding collisions.

That is, if the channel is “idle” for a time corresponding to DCF Inter-frame Space (hereinafter referred to as “DIFS”) in the DCF interval, the MAC performs the backoff during an additional arbitrary time for transmission. Here, the backoff is determined by the number of slot times, and each of the stations determines the number of slot times of a random backoff in a contention window (CW) interval before transferring data. Meanwhile, if the channel is still “busy” even after the random backoff, the slot time is calculated again to wait for a longer backoff time.

FIG. 1 illustrates a data transfer rate upon transmission of multimedia data. These multimedia data need to be transferred at a regular interval of time in view of their multimedia properties. In this figure, packet arrival corresponds to the target transmission quantity for the multimedia data and represents the number ρ of packets (data) constant in quantity, that should be transferred at a predetermined period σ.

As shown in this figure, DIFS and backoff are performed in Packet Service 1 after data transmission, and packet delay is generated upon the generation of collision in a defer area. Here, the defer area is the interval during which IFS (Inter-Frame Space) and backoff are generated. That is, the defer area is an interval during which a station transfers data and then waits to transfer subsequent data and means an interval during which data transmission is not generated. Thus, as the number of times of backoff performance increases, packet delay becomes larger. Consequently, it is difficult to transfer multimedia data.

Meanwhile, Packet Service 2 represents a case where data transmission is affected and then the DIFS and the backoff are performed for a shorter time as compared to Packet Service 1, thereby resulting in a small defer area. That is, since the DIFS and the backoff are performed for a shorter time, packet delay is relatively small and thus multimedia data can be rapidly transferred.

Accordingly, there is needed a method for allowing multimedia data to be rapidly transferred by reducing the packet delay that may be generated upon the transmission of multimedia data in IEEE 802.11 WLAN.

### SUMMARY OF THE INVENTION

The present invention addresses the aforementioned problem. An aspect of the present invention is to provide a method for transmitting multimedia data in a wireless network wherein a waiting time is assigned by an access point in inverse proportion to the quantity of multimedia data to be transmitted by each station per unit time, and thus, multimedia data are transferred according to the data transmission quantity.

It is another aspect of the present invention to provide a method for transmitting multimedia data in a wireless network wherein backoff time and data delay can be reduced by continuously transferring the multimedia data.

Consistent with an aspect of the present invention, there is provided a method for transmitting multimedia data in a wireless network using an access point, comprising receiving information on a data quantity from each station in the wireless network that intends to send multimedia data, and assigning and sending a waiting time to each of the stations based on the received information on the data quantity.

Consistent with another aspect of the present invention, there is provided a method for transmitting multimedia data in a wireless network using an access point, comprising (a) providing, by each station in the wireless network intending to send multimedia data, information on data quantity to the access point, (b) receiving a waiting time assigned by the access point based on the received information on the data quantity, and (c) transferring, by each station, the data through contention in accordance with the assigned waiting time.

Further, the information on the data quantity may contain a transmission quantity per unit time of the multimedia data, and the access point may assign the waiting time to each station in an inverse proportion to the transmission quantity per unit time of the multimedia data.

Furthermore, the waiting time may be assigned in accordance with the number of time slots.

In an exemplary embodiment, step (c) may comprise (c1) contending for data transmission by each station, (c2) transferring the multimedia data to the access point by the station that has won in the contention, and (c3) transferring the data by each station after waiting for a DCF inter-frame space and the assigned waiting time.

In an exemplary embodiment, in step (c2), the station that has won in the contention continuously transfers the multimedia data.

### BRIEF DESCRIPTION OF THE DRAWINGS

The above and other aspects, features and advantages of the present invention will become apparent from the following description of an exemplary embodiment given in conjunction with the accompanying drawings, in which:

FIG. 1 is a graph illustrating a data transfer rate upon transmission of multimedia data;

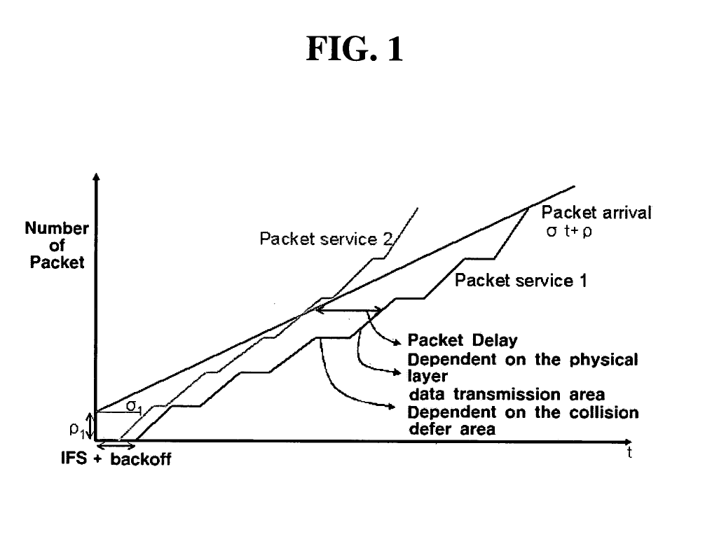

FIG. 2 is a flowchart schematically illustrating a process of transmitting multimedia data in a wireless network consistent with the present invention;

FIG. 3 is a diagram schematically illustrating a process of transmitting multimedia data in a wireless network consistent with the present invention; and

FIG. 4 is a graph illustrating the rate at which multimedia data are transferred in a wireless network consistent with the present invention.

### DETAILED DESCRIPTION OF THE INVENTION

Hereinafter, an exemplary embodiment of the present invention will be described in detail with reference to the accompanying drawings.

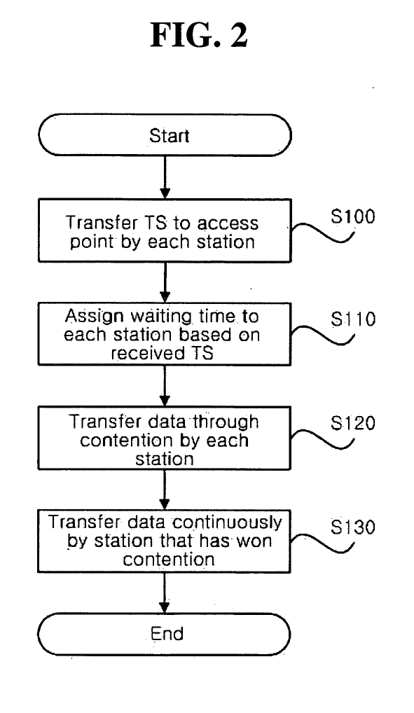

FIG. 2 is a flowchart schematically illustrating the process of transferring multimedia data in a wireless network consistent with the present invention. First, each station that intends to transfer multimedia data sends a traffic specification (hereinafter referred to as “TS”) to an AP (S100). Here, the TS contains information on transmission quantity per unit time of the multimedia data to be transferred by the station. Further, the transmission quantity per unit time means the quantity of data to be transferred per unit time (e.g., per second) in one period. Therefore, the AP can estimate the quantity of data to be transferred by the station, based on the transmission quantity per unit time of the multimedia data.

Meanwhile, only a station that intends to transfer multimedia data can transfer a TS to the AP, whereas other stations with general data do not transfer a TS to the AP. The stations with multimedia data perform backoff for a waiting time assigned by the AP, whereas the stations with general data perform backoff for a waiting time set in the CW interval. Here, the waiting time is determined by the number of slot times, and a slot time corresponds to a time during which data transmission is stopped when a collision is detected after data transmission, i.e. a delay time until the transmission is again attempted after a data transmission signal has caused a collision over a wireless LAN.

Then, the AP assigns a waiting time to a relevant station based on the TS transferred by each of the stations with the multimedia data and transfers the assigned time, to each station (S110). For example, if the transmission quantities per unit time of the multimedia data of the first and second stations are 3 and 2, respectively, the AP assigns waiting times to the first and second stations such that the waiting time of the first station is shorter than that of the second station. That is, it can be understood that data with large transmission quantity per unit time means that a lot of data are to be transferred per unit time. Meanwhile, the AP assigns a shorter waiting time to a station having a larger quantity of data to be transferred so that the station having a larger quantity of data to be transferred can win the contention with the other stations.

Then, in a DCF interval, all of the stations are designed to transfer data through the contention, and a station that has won the contention can transfer the data to the AP (S120). Here, upon data transmission, the relevant station can continuously transfer multimedia data (S130).

Thereafter, while the station that has won the contention transfers data, i.e. when the channel is in use, each of the stations are kept idle during a distributed inter-frame space (DIFS). Then, the other stations take part again in a contention after waiting for their waiting time assigned by the AP. Here, since the shorter waiting time has been assigned to the station having a larger amount of data, there is a highly likelihood that the station with a larger amount of data will win the contention.

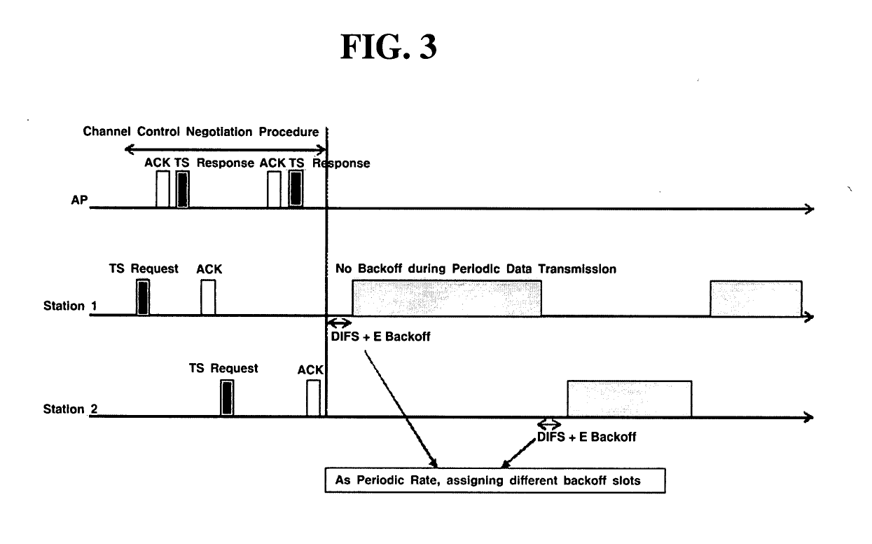

FIG. 3 is a diagram schematically illustrating a process of transmitting multimedia data in a wireless network consistent with the present invention. First, if first and second stations that intend to transfer multimedia data send the TS to the AP, the AP sends back an acknowledgement signal (ACK) to the first and second stations. Here, the AP assigns a waiting time based on transmission quantity per unit time of each station and transfers the acknowledgement signal with the assigned waiting time contained therein. For example, when the transmission quantities per unit time of the multimedia data to be transferred by the first and second stations are 3 and 2, respectively, the AP assigns a shorter waiting time to the first station as compared to that of the second station because the transmission quantity per unit time to be transferred by the first station is larger than that of the second station.

Thereafter, if the first and second stations are to transmit the data to the AP through contention, they will be kept idle for a DIFS interval and further wait for their waiting time (i.e., backoff time) assigned by the AP, and then start to transmit data. At this time, since the AP has assigned a shorter waiting time to the first station than the second station, the first station would win the contention, thereby enabling preferential data transmission. Here, upon transmission of the multimedia data, the first station can continuously transfer data without performing any backoff. For example, if a station transmits one data unit at a time, three backoffs must be performed to transfer the data because the transmission quantity per unit time of the first station is 3. Consistent with an exemplary embodiment of the present invention, however, it is possible to transfer the data only after one backoff because multimedia data can be continuously transferred at one time.

Then, after the first station has transferred all the multimedia data, the second station can continuously transfer its multimedia data. Thereafter, the first and second stations can repeatedly transfer data.

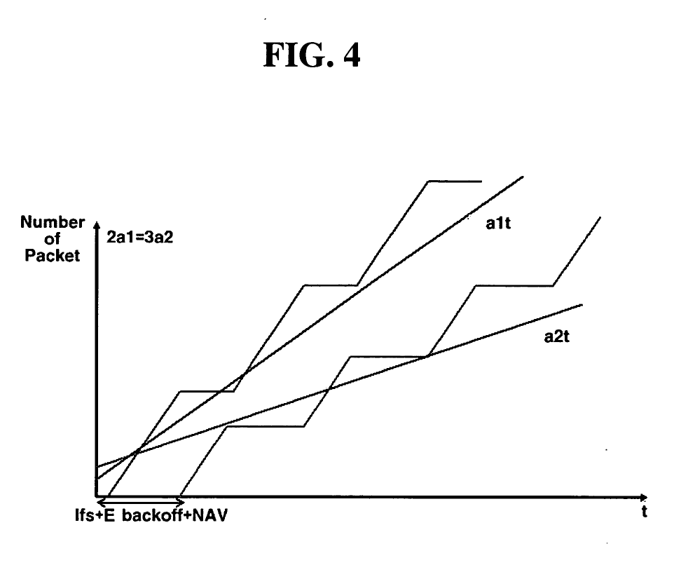

FIG. 4 is a graph illustrating a rate at which multimedia data are transferred in a wireless network consistent with the present invention. Referring to this figure, a case where the first and second stations intend to transfer the data through contention will be described by way of example.

It is assumed that 2a₁=3a₂ and thus a₁=3/2a₂, where a1 is the transmission quantity per unit time of the first station and a2 is the transmission quantity per unit time of the second station. In such a case, the AP assigns a shorter waiting time to the first station because the transmission quantity per unit time of the first station is 1.5 times larger than that of the second station.

As shown in FIG. 4, the first station performs a backoff shorter than that of the second station and then transfers the data, during which the first station can continuously send the multimedia data. Consequently, data transmission delay can be reduced.

Therefore, a station having a larger amount of data to be transferred can obtain more opportunities to transfer the data preferentially than stations having a smaller amount of data to be transferred. Further, the station can continuously transfer data without performing several backoffs, so that data transmission delay can be reduced.

Consistent with the present invention as described above, there is an advantage in that data can be preferentially transferred in accordance with the data transmission quantity of each station since the AP assigns a waiting time in inverse proportion to the data transmission quantity per unit time of the multimedia data to be transferred by each station.

Further, upon the transmission of multimedia data, the data can be continuously transmitted so that backoff time can be reduced. Therefore, there is another advantage in that data transmission delay can be reduced.

Although the present invention has been described in connection with the exemplary embodiment thereof, it is not limited thereto. It will be apparent to those skilled in the art that various changes and modifications can be made thereto without departing from the scope and spirit of the present invention defined by the appended claims. Accordingly, such modifications and changes will fall within the scope of the invention.

1. A method for transmitting multimedia data in a wireless network using an access point, comprising:
receiving information on a data quantity from each station in the wireless network that intends to send multimedia data; and
assigning and sending a waiting time to each of the stations based on the received information on the data quantity.

2. The method as claimed in claim 1, wherein the information on the data quantity contains a transmission quantity of the multimedia data per unit time.

3. The method as claimed in claim 2, wherein the access point assigns the waiting time to each station in inverse proportion to the transmission quantity of the multimedia data per unit time.

4. The method as claimed in claim 1, wherein the waiting time is assigned in accordance with a number of time slots.

5. The method as claimed in claim 3, wherein the waiting time is assigned in accordance with a number of time slots.

6. A method for transmitting multimedia data in a wireless network using an access point, comprising:
providing, by each station in the wireless network intending to send multimedia data, information on data quantity to the access point;
receiving a waiting time assigned by the access point based on the received information on the data quantity; and
transferring, by each station, the data through contention in accordance with the assigned waiting time.

7. The method as claimed in claim 6, wherein the information on the data quantity contains a transmission quantity of the multimedia data per unit time.

8. The method as claimed in claim 7, wherein the access point assigns the waiting time to each station in inverse proportion to the transmission quantity of the multimedia data per unit time.

9. The method as claimed in claim 6, wherein the waiting time is assigned in accordance with a number of time slots.

10. The method as claimed in claim 8, wherein the waiting time is assigned in accordance with a number of time slots.

11. The method as claimed in claim 6, wherein transferring the data through contention comprises:
causing the stations to contend for data transmission;
transferring the multimedia data to the access point by the station that has won the contention; and
transferring the data by each station after waiting for a distributed coordination function (DCF) inter-frame space and the assigned waiting time.

12. The method as claimed in claim 11, wherein when transferring the multimedia data to the access point, the station that has won the contention continuously transfers the multimedia data without performing any backoff.
